(19) United States
(12) Patent Application Publication
(10) Pub. No.: US 2026/0030734 A1
(43) Pub. Date: Jan. 29, 2026

(54) SECURE DISPOSAL OF COMPUTING DEVICES VIA AUTOMATED HARD DRIVE DESTRUCTION

(71) Applicant: BANK OF AMERICA CORPORATION, Charlotte, NC (US)

(72) Inventors: Kyle Mayers, Charlotte, NC (US); Elizabeth R. Liuzzo, Fort Mill, SC (US); Justin Miller, Fort Mill, SC (US)

(73) Assignee: BANK OF AMERICA CORPORATION, Charlotte, NC (US)

(21) Appl. No.: 18/782,885

(22) Filed: Jul. 24, 2024

(51) Int. Cl. G06T 7/00; G06F 21/44; G06T 7/60

(52) U.S. Cl. CPC G06T 7/0004; G06F 21/44; G06T 7/60; G06T 2207/20081

(57) ABSTRACT

A self-service means for securely and efficiently destroying computing devices, specifically the permanent storage/memory devices/units within such computing devices. An apparatus, such as a kiosk receives a user's computing device and, in response, an image-capturing device(s) is activated to capture images of the computing device. The captured images serve as inputs to Machine Learning (ML) models that have been trained to determine/predict the location of permanent storage/memory devices/units within the computing devices. Once the location has been determined, a physical destruction element is activated at the determined/predicted location to destroy the permanent storage/memory devices/units.

### FIELD OF THE INVENTION

The present invention is generally directed to data security and, more specifically, providing users with a self-service means for destroying the permanent storage devices (e.g., hard drive disks, solid-state disks, non-volatile flash memory and the like) in unwanted computing devices.

### BACKGROUND

When computing devices are no longer being used, such as when devices are no longer operable or being replaced, difficulty arises in ensuring that the data permanently stored thereon, which may include a user's personal and/or confidential data, is not accessible by others who come into possession of the device. In this regard, the only sure-proof means for ensuring data security is destruction of the computing device or, more specifically destruction of the computing device's permanent memory units, such as hard drive disks, solid-state disks, non-volatile flash memory and the like. Unfortunately, most current destruction methodologies are inefficient and pose security threats. Often times, users of the computing devices have to rely on third-party entities to destroy the device and/or the permanent storage units. However, since the user typically turns over possession of the computing device to the third-party entity, such practice does not alleviate concerns that the data permanently stored on the device may be misappropriated by the third-party prior to destruction or by a fourth party entity interfering in the transfer of the computing device from the user to the third-party entity.

Therefore, a need exists to develop apparatus, computer-implemented methods, computer program products or the like that efficiently and securely destroy computing device or, more specifically, the permanent memory/storage devices/units included within such computing devices. The desired apparatus, computer-implemented method should allow for the destruction of the permanent memory/storage devices/units to occur without requiring the user to submit the computing device to a third-party entity. Further, the desired apparatus, computer-implemented method should provide for efficient and accurate locating of the permanent memory/storage devices/units within the computing devices for purposes of subsequent destruction.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing users a self-service means for destroying computing devices, specifically the permanent storage/memory devices/units within such computing devices. In this regard, the invention embodies an apparatus, such as a kiosk having a housing with a receptacle for receiving a user's computing device. Once the computing device has been received at the kiosk, an image-capturing device(s) is activated to capture images of the computing device. The captured images serve as inputs to Machine Learning (ML) models that have been trained to determine/predict the location of permanent storage/memory devices/units within the computing devices. The permanent storage/memory device will vary depending on the type of device and may include a hard disk drive, a solid-state drive, non-volatile flash memory or the like. Once the location has been determined, a physical destruction element is activated at the determined/predicted location to destroy the permanent storage/memory devices/units. The physical destruction element may be a cutting element, such as a drill, saw, or laser, a burning element, a pulverizer or the like.

In specific embodiments of the invention, the captured images are used to determine dimensions of the computing device and the dimensions, as well as the images themselves serve as inputs to ML model(s) that have been trained to determine/predict the location of permanent storage/memory devices/units within the computing devices. In other specific embodiments of the invention, the captured images, and in some embodiments dimensions, serve as inputs to ML model(s) that have been trained to identify the computing device (e.g., determine make and/or model of the computing device) and subsequently the identification of the computing device serves as an input to other ML model(s) that have been trained to determine/predict the location of permanent storage/memory devices/units within the computing devices. In specific embodiments of the invention, the ML models implement computer vision techniques to render a graphical representation, such as a plot-out, of the location of the permanent storage device(s).

In specific embodiments of the invention, once the permanent storage/memory device(s)/unit(s) have been destroyed a record is generated that identifies the user, the computing device and time/date of the destruction. In specific embodiments of the invention, the image-capturing device(s) is/are activated to capture video and/or images of the destruction process and, the video and/or images are included in the record. The record is stored in an associated database and/or communicated to the user.

In further specific embodiments of the invention, the computing device may be authorized for destruction prior to the destruction proceeding. The authorization may include acquiring the unique identifier (e.g., serial number) of the computing device and accessing a do-not-destroy database to determine if the unique identifier (i.e., the computing device) is listed therein. If the unique identifier is not found in the database/list, the computing device is authorized for destruction and if the unique identifier is found in the database/list, the computing device is denied destruction. In other embodiments of the invention, authorization may include verifying that the user is the rightful possessor of the computing device (e.g., activating the device and applying user credentials to access the computing device).

An apparatus for secure physical destruction of computing devices defines first embodiments of the invention. The includes a housing having a receptacle configured to receive a computing device from a user. In specific embodiments of the system, the housing is part of a kiosk, such that the apparatus provides users self-service destruction of a portion of computing devices, specifically the permanent storage devices/unit of the computing devices.

The system additionally includes a computing platform that is disposed within the housing and includes a memory, one or more computing processor devices in communication with the memory, at least one image capturing device (e.g., camera, video recorder) or the like in communication with at least one of the computing processor device(s) and a physical destruction element in communication with at least one of the computing processor device(s). In specific embodiments of the invention, the physical destruction element may consist of a cutting element (e.g., drill, saw or the like), a pulverizer or a heating/burning element.

The computing platform additionally includes a storage device location-determining module including one or more trained Machine Learning (ML) models. The storage device location-determining module is stored in the memory and executable by at least one of the computing processor device(s). The storage device location-determining module is configured to, upon receipt of the computing device, activate the image capturing device(s) to capture one or more first images of the computing device and, using the captured first image(s) of the computing device, execute first ML model(s) from amongst the trained ML model(s) to determine or predict a location for at least one permanent storage device within the computing device. The permanent storage device may consist of a hard disk drive, a solid-state drive and/or non-volatile flash memory.

In addition, computing platform additionally includes a physical destruction module that is stored in the memory and executable by at least one of the computing processor device(s). The physical destruction module is configured to receive the location(s) for the least one permanent storage device within computing device, and, in response, activate the physical destruction element at the location(s) to physically destroy the at least one permanent storage device within the computing device.

In specific embodiments of the apparatus, the storage device location-determining module is further configured to use the captured first image(s) of the computing device as inputs to second ML models from amongst the trained ML model(s) to identify the computing device, i.e., determine or predict at least one of a manufacturer and a model number of the computing device. Subsequently, the determined manufacturer and/or model number of the computing device are used as inputs the first ML model(s) to determine or predict the location for the permanent storage device(s) within the computing device.

In other specific embodiments of the apparatus, the storage device location-determining module is further configured to activate the image capturing device(s) to determine physical dimensions of the computing device and subsequent, using the physical dimensions of the computing device along with the images, execute the first ML model(s) to determine or predict a location for at least one permanent storage device within the computing device.

In still further embodiments of the apparatus, the storage device location-determining module is further configured to execute the first ML model(s) to determine or predict a location for at least one permanent storage device within the computing device, such that the first ML model(s) implement computer vision techniques that are configured to provide a visual representation (e.g., a plot-out or the like) of the location of the at least one permanent storage device within the computing device.

In further specific embodiments of the apparatus, the computing platform includes a physical destruction record module stored in the memory and executable by at least one of the computing processor device(s). The physical destruction record module is configured to generate a physical destruction record that includes, but is not limited to, (i) an identity of the user, (ii) a unique identifier for the computing device and (iii) a time/date at which the permanent storage device(s) was/were physically destroyed. In specific embodiments of the apparatus, a physical destruction record module acquires the unique identifier of the computing device, for example in those embodiments in which the unique identifier is a serial number, an image of a serial number displayed on the computing device may be captured or the user may input the serial number. In other example, in which the unique identifier is an International Mobile Equipment Identity (IMEI) number, the computing device may be activated and the IMEI retrieved from the settings or the user may input the IMEI number.

In further embodiments of the apparatus, the computing platform further includes physical destruction authorization module that is stored in the memory and executable by at least one of the computing processor devices. The physical destruction authorization module is configured to acquire a unique identifier for the computing device (e.g., (i) a serial number of the computer device, (ii) an International Mobile Equipment Identity (IMEI) number or the like) and, in response, access a device database that includes identifiers for computing devices that are not authorized for destruction (i.e., a so-called do-not destroy database/listing) and verify that the identifier for the computing device is not listed within the device database. In response to verifying that the identifier of the computing device is not listed within the device database, authorize the computing device for physical destruction of permanent storage devices. In related embodiments of the apparatus, the physical destruction authorization module is further configured to access the device database and determine that the identifier for the computing device is listed within the device database, and, in response to determining that the identifier of the computing device is listed within the device database, deny the computing device from undergoing physical destruction of permanent storage devices. In further related embodiments of the physical destruction authorization module is further configured to, in response to determining that the identifier of the computing device is listed within the device database, activate one or more of the at least image capturing devices to capture an image of the user, and initiate communication of the image of the user to a third-party entity (e.g., investigative third-party entity or the like).

In still further related embodiments of the apparatus, the computer platform includes a physical destruction authorization module that is stored in the memory and executable by the at least one of the one or more computing processor devices. The physical destruction authorization module is configured to verify that the user is an authorized user of the computing device (e.g., activate device and provide user access credentials or the like), and, in response to verifying that the user is the authorized user of the computing device, authorize the computing device for physical destruction of permanent storage devices.

A computer-implemented method for secure physical destruction of computing devices defines second embodiments of the invention. The computer-implemented method is executed by one or more computing processor device. The computer-implemented method includes activating at least one image capturing device disposed within a housing to first image(s) of a computing device located within the housing. The computer-implemented method further includes using the captured first image(s) of the computing device to execute first ML model(s) to determine or predict a location for at least one permanent storage device within the computing device, wherein the least one permanent storage device includes at least one of a hard disk drive and a solid-state drive. In addition, the computer-implemented method includes, in response to determining or predicting the location, activating a physical destruction element disposed within the housing at the location to physically destroy the at least one permanent storage device within the computing device.

In specific embodiments of the computer-implemented method using the captured first image(s) of the computing device to execute the first ML model(s) to determine or predict the location for the at least one permanent storage device further includes implementing computer vision techniques that are configured to provide a visual representation of the location of the at least one permanent storage device within the computing device.

In other specific embodiments the computer-implemented method includes acquiring a unique identifier for the computing device. The unique identifier is one chosen from the group consisting of (i) a serial number of the computer device, and (ii) International Mobile Equipment Identity (IMEI) number, activating at least one image capturing device to capture at least one of a video or second image(s) of the physical destruction element destroying the at least one permanent storage device within the computing device, and generating a physical destruction record that includes (i) an identity of the user, (ii) a unique identifier for the computing device and (iii) a time at which the at least one permanent storage device was physically destroyed, and (iv) the at least one of the video and the one or more second images. The computer-implemented method further includes initiating communication of the physical destruction record to at least one of (i) the user and (ii) a physical destruction database.

In still other specific embodiments, the computer-implemented method includes acquiring a unique identifier for the computing device. The identifier is one chosen from the group consisting of (i) a serial number of the computer device, and (ii) International Mobile Equipment Identity (IMEI) number, accessing a device database that includes identifiers for computing devices that are not authorized for destruction and verifying that the identifier for the computing device is not listed within the device database, and, in response to verifying that the identifier of the computing device is not listed within the device database, authorizing the computing device for physical destruction of permanent storage devices.

A computer program product including a non-transitory computer-readable medium defines third embodiments of the invention. The non-transitory computer-readable medium includes a set of codes for causing one or more computing devices to activate at least one image capturing device disposed within a housing to capture one or more first images of a computing device located within the housing. The computer-readable medium further includes a set of codes for causing the computing device(s) to use the captured one or more first images of the computing device to execute one or more first ML models to determine or predict a location for at least one permanent storage device within the computing device. The permanent storage device includes at least one of a hard disk drive, a solid-state drive, or a non-volatile flash memory. Further, the computer-readable medium includes a set of codes for causing the computer device(s) to, in response to determining or predicting the location, activate a physical destruction element disposed within the housing at the location to physically destroy the at least one permanent storage device within the computing device.

In specific embodiments of the computer program product, the set of code for causing the one or more computing devices to use the captured one or more first images of the computing device to execute one or more first ML models to determine or predict a location for at least one permanent storage device within the computing device are further configured to cause the one or more computing devices to implement computer vision techniques that are configured to provide a visual representation of the location of the at least one permanent storage device within the computing device.

In other specific embodiments of the computer program product, the computer-readable medium further includes sets of codes for causing the computing device(s) to acquire a unique identifier for the computing device. The unique identifier is one chosen from the group consisting of (i) a serial number of the computer device, and (ii) International Mobile Equipment Identity (IMEI) number. In addition, the computer-readable medium includes sets of codes for causing the computing device(s) to activate at least one image capturing device to capture at least one of a video or one or more second images of the physical destruction element destroying the at least one permanent storage device within the computing device, generate a physical destruction record that includes (i) an identity of the user, (ii) a unique identifier for the computing device and (iii) a time at which the at least one permanent storage device was physically destroyed, and (iv) the at least one of the video and the one or more second images; and initiate communication of the physical destruction record to at least one of (i) the user and (ii) a physical destruction database.

Moreover, in additional specific embodiments the computer program product, the computer-readable medium includes sets of codes for causing the one or more computing devices to acquire a unique identifier (e.g., (i) a serial number of the computer device, or (ii) an International Mobile Equipment Identity (IMEI) number for the computing device), access a device database that includes identifiers for computing devices that are not authorized for destruction and verifying that the identifier for the computing device is not listed within the device database, and in response to verifying that the identifier of the computing device is not listed within the device database, authorize the computing device for physical destruction of permanent storage devices.

Thus, as described in detail above, present embodiments of the invention include apparatus, methods, computer program products and/or the like that provide for a self-service means for destroying computing devices, specifically the permanent storage/memory devices/units within such computing devices. In this regard, the invention embodies an apparatus, such as a kiosk with a receptacle for receiving a user's computing device. Once the computing device has been received at the kiosk, an image-capturing device(s) is activated to capture images of the computing device. The captured images serve as inputs to Machine Learning (ML) models that have been trained to determine/predict the location of permanent storage/memory devices/units within the computing devices. The permanent storage/memory device will vary depending on the type of device and may include a hard disk drive, a solid-state drive, non-volatile flash memory or the like. Once the location has been determined, a physical destruction element is activated at the determined/predicted location to destroy the permanent storage/memory devices/units. The physical destruction element may be a cutting element, such as a drill, saw, or laser, a burning element, a pulverizer or the like.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic of an apparatus for secure physical destruction of computing devices, in accordance with embodiments of the present invention;

FIG. 2 is a schematic/block diagram of an apparatus for secure physical destruction of computing devices, in accordance with embodiments of the present invention, in accordance with embodiments of the present invention;

FIGS. 3A and 3B are block diagrams of a computing platform for secure physical destruction of computing devices, in accordance with embodiments of present invention;

FIG. 4 is a flow diagram of a computer-implemented method for secure physical destruction of computing devices, in accordance with embodiments of the invention; and

FIG. 5 is a schematic diagram of an exemplary machine learning (ML) subsystem architecture, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform includes a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that by provide users a self-service means for securely and efficiently destroying computing devices, specifically the permanent storage/memory devices/units within such computing devices. In this regard, the invention embodies an apparatus, such as a kiosk having a housing with a receptacle for receiving a user's computing device. Once the computing device has been received at the kiosk, an image-capturing device(s) is activated to capture images of the computing device. The captured images serve as inputs to Machine Learning (ML) models that have been trained to determine/predict the location of permanent storage/memory devices/units within the computing devices. The permanent storage/memory device will vary depending on the type of device and may include a hard disk drive, a solid-state drive, non-volatile flash memory or the like. Once the location has been determined, a physical destruction element is activated at the determined/predicted location to destroy the permanent storage/memory devices/units. The physical destruction element may be a cutting element, such as a drill, saw, or laser, a burning element, a pulverizer or the like.

In specific embodiments of the invention, the captured images are used to determine dimensions of the computing device and the dimensions, as well as the images themselves serve as inputs to ML model(s) that have been trained to determine/predict the location of permanent storage/memory devices/units within the computing devices. In other specific embodiments of the invention, the captured images, and in some embodiments dimensions, serve as inputs to ML model(s) that have been trained to identify the computing device (e.g., determine make and/or model of the computing device) and subsequently the identification of the computing device serves as an input to other ML model(s) that have been trained to determine/predict the location of permanent storage/memory devices/units within the computing devices. In specific embodiments of the invention, the ML models implement computer vision techniques to render a graphical representation, such as a plot-out, of the location of the permanent storage device(s).

In specific embodiments of the invention, once the permanent storage/memory device(s)/unit(s) have been destroyed a record is generated that identifies the user, the computing device and time/date of the destruction. In specific embodiments of the invention, the image-capturing device(s) is/are activated to capture video and/or images of the destruction process and, the video and/or images are included in the record. The record is stored in an associated database and/or communicated to the user.

In further specific embodiments of the invention, the computing device may be authorized for destruction prior to the destruction proceeding. The authorization may include acquiring the unique identifier (e.g., serial number) of the computing device and accessing a do-not-destroy database to determine if the unique identifier (i.e., the computing device) is listed therein. If the unique identifier is not found in the database/list, the computing device is authorized for destruction and if the unique identifier is found in the database/list, the computing device is denied destruction. In other embodiments of the invention, authorization may include verifying that the user is the rightful possessor of the computing device (e.g., activating the device and applying user credentials to access the computing device).

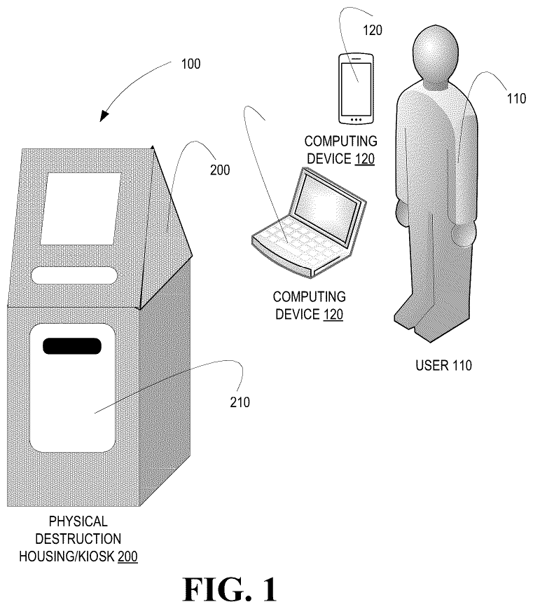

Referring to FIG. 1, a schematic is presented of an apparatus 100 for secure physical destruction of computing devices, in accordance with embodiments of the present invention. The apparatus 100 includes a physical destruction housing 200, which in the illustrated embodiment of FIG. 1 is a self-service kiosk. The housing 200 includes a receptacle 210 that is configured to receive a computing device 120 from a user 110. The computing device 120 may comprise, as shown in FIG. 1, a laptop, a mobile communication device (e.g., smart phone) or any other computing device (e.g., hard drive of a PC or the like) which the user 110 desires to dispose of. As previously discussed, when a computing device is no longer needed by a user, the user has a need to properly dispose of the computing device, including ensuring that the data stored within permanent storage/memory units/devices is not accessible to anyone who comes into possession of the device. In this regard, the only sure-proof means for securely disposing of the permanent storage devices is physical destruction. Once the user 110 has placed the computing device 120 into the housing/kiosk 200 via receptacle 210, computing processing within the housing/kiosk, as explained in detail infra., is configured to locate the permanent storage unit(s)/device(s) within the computing device, and, in response, physically destroy the permanent storage units/device(s). In specific embodiments, the location of the permanent storage unit(s)/device(s) and subsequent destruction of the permanent storage unit(s)/device(s) occurs without requiring that the user 110 provide any computing device identifying data, such as manufacturer name, model number or the like.

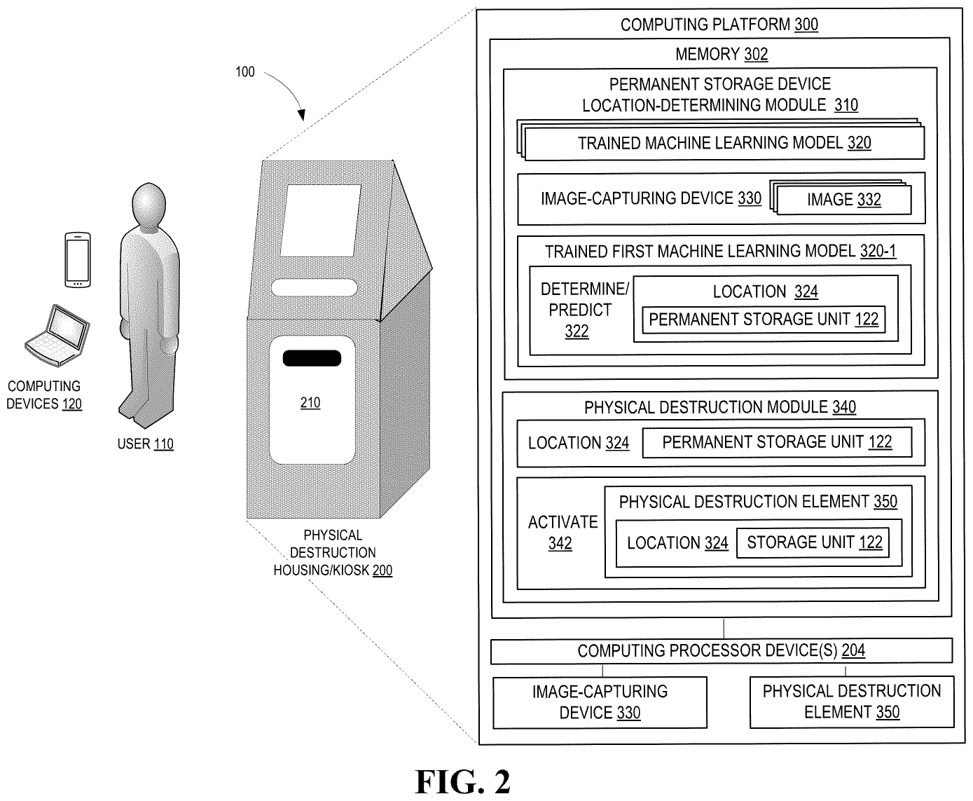

Referring to FIG. 2, a schematic/block diagram is presented of an apparatus 100 for secure physical destruction of computing devices, in accordance with embodiments of the present invention. As discussed in relation to FIG. 1, apparatus 100 includes physical destruction housing 200, which may take the form of a self-service kiosk. The housing 200 includes a receptacle 210 that is configured to receive a computing device 120 from a user 110.

The apparatus additionally includes a computing platform 300 that is disposed within the housing 200. Computing platform 300 includes memory 202 and at least one computing processor device 204 in communication with memory 202. In addition, computing platform 300 includes at least one image-capturing device 330, such as a camera, video recorder or the like in communication with at least one of the computing processor device(s) 210 and a physical destruction element 350 in communication with at least one of the computing processor device(s) 210. The physical destruction element 350 may be a cutting element, such as a drill, saw, laser or the like; a pulverizer or some other element suitable for grinding; or a burning element, such as flame element, laser or the like.

Additionally, computing platform 300 includes permanent storage device location-determining module 310, which includes one or more trained Machine Learning (ML) models 320. Permanent storage device location-determining module 310 is stored in memory 302 and executable by at least one of computing processor device(s) 304. In response to housing 200 receiving computing device 120, permanent storage device location-determining module 310 is configured to activate one or more of image capturing device(s) 330 to capture first images 332 of the computing device 120. Robotics mechanisms (not shown in FIG. 2) may be implemented to move and position computing device 120 throughout housing 200 for purposes of image capture and subsequent physical destruction. In specific embodiments of the apparatus 100, one moveable image-capturing device 330 is implemented to capture first images 332 of various views of computing device 120, while in other embodiments multiple stationary image-capturing devices 330 are implemented to capture first images 332 of various views of computing device 120.

In response to capturing first images 332, one or more first trained ML models 320-1 are executed, using the first images 332 as input, to determine/predict 3322 a location 324 for each permanent storage unit 122 in the computing device 120. The permanent storage device/unit 122 may include, but is not limited to, a hard disk drive, a solid-state drive, a non-volatile flash memory device or the like. The location 324 of permanent storage device/unit varies depending upon the type of computing device 120 (e.g., laptop, tablet, mobile communication device, and the like), as well as the manufacturer and/or model of computing device. Thus, first ML models 320-1 may be trained on image recognition techniques to recognize the make/model of a specific computing device 120 and, based on the make/model of the computing device 120 determine, or in some instances predict, 322 the location 324 of the permanent storage device(s)/units 122 located therein.

Computing platform 300 additionally includes physical destruction module 340 that is stored in memory 302 and executable by at least one of computing processor device(s) 304. In response to permanent storage device location-determining module 310 determining/predicting 322 the location 324 of the permanent storage device(s)/unit(s) 122, physical destruction module 340 is configured to receive the location(s) 324 of the permanent storage unit 122 and activate the physical destruction element 350 at the location(s) 324 to physically destroy the permanent storage device(s) 122 within the computing device 120. As previously mentions, robotics mechanisms (not shown in FIG. 2) may be implemented to position the computing device 120 proximate the physical destruction element 350 such that the physical destruction element 350 is activated specifically at the location(s) 324 of the permanent storage device(s)/unit(s) 122.

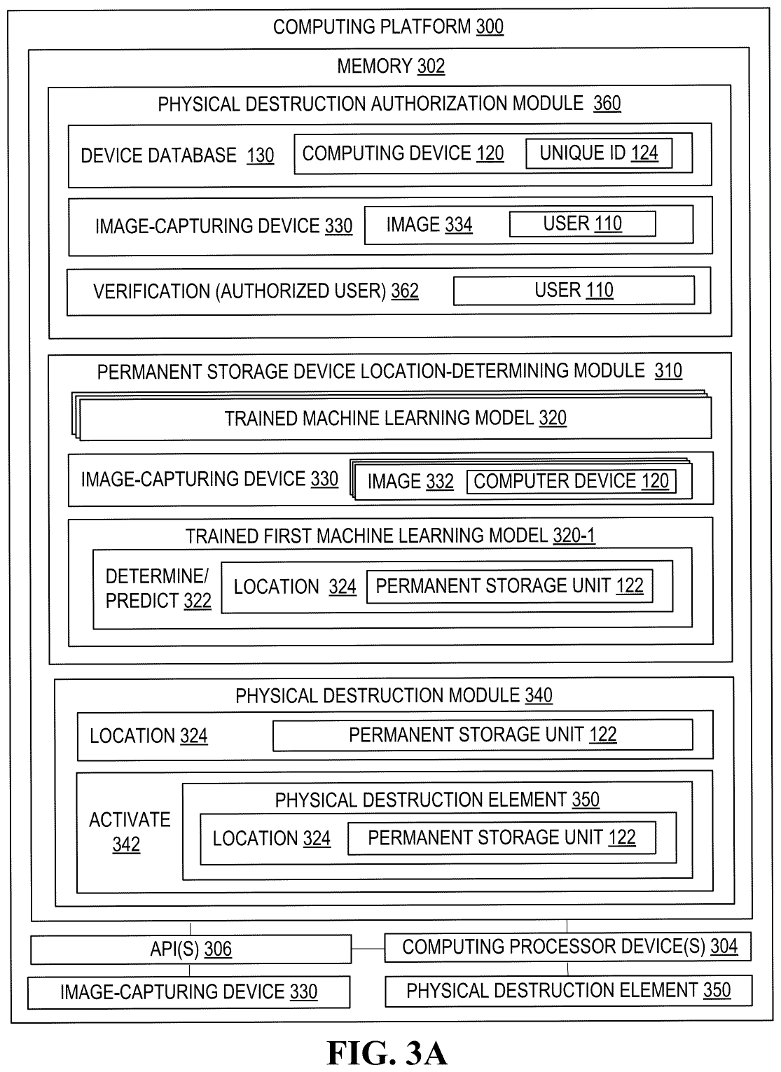

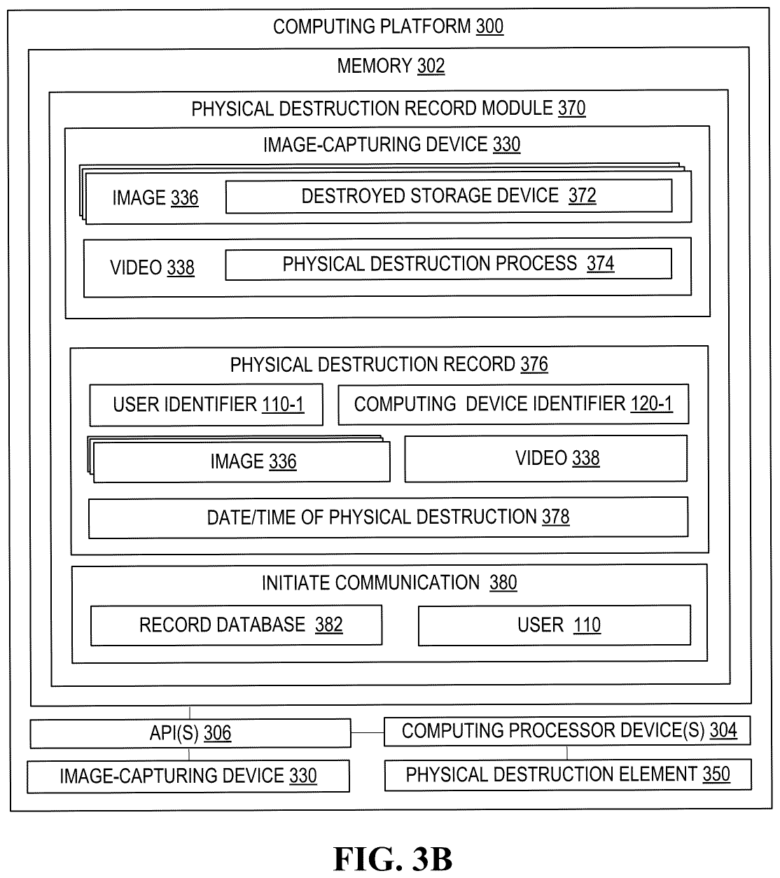

Referring to FIGS. 3A and 3B, block diagrams are depicted of computing platform 300 highlighting various alternate embodiments of the apparatus, in accordance with embodiments of the present invention. Computing platform 300 may comprise one or multiple computing devices or the like. As previously discussed in relation to FIG. 2, computing platform 300 includes memory 302, which may comprise volatile and/or non-volatile memory, such as read-only memory (ROM) and/or random-access memory (RAM), EPROM, EEPROM, flash cards, or any memory common to computing platforms. Moreover, memory 302 may comprise cloud storage, such as provided by a cloud storage service and/or a cloud connection service.

Further, computing platform 300 includes one or more computing processor devices 304, which may be an application-specific integrated circuit (“ASIC”), or other chipset, logic circuit, or other data processing device. Computing processor device(s) 304 may execute one or more application programming interface (APIs) 306 that interface with any resident programs, such as permanent storage device location-determining module 310, physical destruction module 340, physical destruction authorization module 360, physical destruction record module 370 or the like, stored in memory 302 of computing platform 300 and any external programs. Computing platform 300 includes various processing sub-systems (not shown in FIG. 3) embodied in hardware, firmware, software, and combinations thereof, that enable the functionality of computing platform 300 and the operability of computing platform 300 on a distributed communication network. For example, processing sub-systems allow for initiating and maintaining communications and exchanging data with other networked devices. For the disclosed aspects, processing sub-systems of computing platform 300 includes any processing sub-system portion used in conjunction with permanent storage device location-determining module 310, physical destruction module 340, physical destruction authorization module 360, physical destruction record module 370 and tools, routines, sub-routines, applications, sub-applications, sub-modules thereof.

In specific embodiments of the present invention, computing platform 300 additionally includes a communications module (not shown in FIG. 3) embodied in hardware, firmware, software, and combinations thereof, that enables electronic communications between components of computing platform 300 and other networks and network devices. Thus, communication module includes the requisite hardware, firmware, software and/or combinations thereof for establishing and maintaining a network communication connection with one or more devices and/or networks.

In additional embodiments of the apparatus 100, memory 320 of computing platform 300 stores physical destruction authorization module 360 that is executable by at least one of computing processor device(s) 304. Physical destruction authorization may occur upon computing device receipt (i.e., prior to permanent storage location and physical destruction). In specific embodiments of the apparatus, physical destruction authorization module 360 is configured to acquire a unique identifier 124 of the computing device 120. The unique identifier 124 may be serial number or an International Mobile Equipment Identity (IMEI) number. The unique identifier 124 may be acquired by capturing an image of serial number on a computing device that displays such on an exterior facing, activating the device and obtaining the serial number or IMEI from the settings or through user interface (e.g., at a user interface (display/keypad) on the front of the housing/kiosk 200) or the like. In response to acquiring the unique identifier 124, physical destruction authorization module 360 is configured to access a device database 130 that includes a listing of computing devices that are not authorized for physical destruction (i.e., a do-not-destroy listing). Computing devices that have gone missing (e.g., misplacement or misappropriation) and have been reported as such, may be added to the listing within the device database 130.

In response to accessing the device database 130 and verifying that the unique identifier 124 for the computing device 120 is not listed within the device database 130, physical destruction authorization database is configured to authorize the computing device 120 for physical destruction of the associated permanent storage devices 122. Conversely, in response to accessing the device database 130 and determining that the unique identifier 124 is listed within the device database 130, physical destruction authorization database is configured to deny the computing device 120 from being physically destroyed. In specific embodiments of the apparatus, in response to determining that the unique identifier 124 is listed within the device database 130, physical destruction authorization database is configured to activate at least one of the image-capturing devices 330 (i.e., an exterior-facing image-capturing device) to capture one or more images 334 of the user 110 and initiate communication of the image(s) 334 to a third-party investigative entity (e.g., law enforcement or the like). Capturing images 334 of the user 110 in this instance, assumes that the user 110 is a wrongful possessor of the computing device 120 and may be attempting to maliciously destroy the computing device (e.g., destroy evidence or the like).

In further embodiments of the apparatus 100, physical destruction authorization module 360 is configured to perform a verification 362 that the user 362 is an authorized user of the computing device and, thus, within right to pursue destruction of the computing device 120/permanent storage devices 122. Such verification may be accomplished by receiving user credentials (e.g., via user input at display/keypad on the housing/kiosk 100) and activating the device to verify that the user credentials provide access to the computing device 120. In other instances, verification may be accomplished by receiving user credentials/user identifier and device identifier and accessing a database that associates users with computing devices. In response to verifying that the user is the authorized user of the computing device, physical destruction authorization module 360 is configured to authorize the user 110 to proceed with physical destruction of the of permanent storage devices 122 within the computing device 120. Conversely, in response to the verification 362 failing to verify the user 110 as an authorized user/rightful possessor, physical destruction authorization database is configured to deny the user 110 from proceeding with physical destruction of the of permanent storage devices 122 within the computing device 120.

As previously discussed in relation to FIG. 2, computing platform 300 includes permanent storage device location-determining module 310, which includes one or more trained Machine Learning (ML) models 320. Permanent storage device location-determining module 310 is stored in memory 302 and executable by at least one of computing processor device(s) 304. In response to housing 200 receiving computing device 120, permanent storage device location-determining module 310 is configured to activate one or more of image capturing device(s) 330 to capture first images 332 of the computing device 120. Robotics mechanisms (not shown in FIG. 2) may be implemented to move and position computing device 120 throughout housing 200 for purposes of image capture and subsequent physical destruction. In specific embodiments of the apparatus 100, one moveable image-capturing device 330 is implemented to capture first images 332 of various views of computing device 120, while in other embodiments multiple stationary image-capturing devices 330 are implemented to capture first images 332 of various views of computing device 120. In further specific embodiments of the images 332 are captured to determine physical dimensions of the computing device 120.

In response to capturing first images 332, one or more first trained ML models 320-1 are executed, using the first images 332 and, in some embodiments, the physical dimensions of the computing device 120 as input, to determine/predict 3322 a location 324 for each permanent storage unit 122 in the computing device 120. The permanent storage device/unit 122 may include, but is not limited to, a hard disk drive, a solid-state drive, a non-volatile flash memory device or the like. The location 324 of permanent storage device/unit varies depending upon the type of computing device 120 (e.g., laptop, tablet, mobile communication device, and the like), as well as the manufacturer and/or model of computing device. Thus, first ML models 320-1 may be trained on image recognition techniques to recognize the make/model of a specific computing device 120 and, based on the make/model of the computing device 120 determine, or in some instances predict, 322 the location 324 of the permanent storage device(s)/units 122 located therein. In specific embodiments the first ML models 320-1 implement computer vision techniques that are configured to provide a visual representation (e.g., graphical representation, such as a plot-out) of the location of the at least one permanent storage device within the computing device.

In other embodiments of the apparatus 100, permanent storage device location-determining module 310 is configured to execute second trained ML models, using the first images 332 as input, to determine, or in some instances predict, at least one of the manufacturer and a model number of the computing device 120. In response, permanent storage device location-determining module 310 is configured to execute first trained ML models, using the first images 332 and the manufacture and/or model number as inputs, to determine, or in some instances predict, the location 324 for the at least one permanent storage device 122 within the computing device 120.

Computing platform 300 additionally includes physical destruction module 340 that is stored in memory 302 and executable by at least one of computing processor device(s) 304. In response to permanent storage device location-determining module 310 determining/predicting 322 the location 324 of the permanent storage device(s)/unit(s) 122, physical destruction module 340 is configured to receive the location(s) 324 (e.g., graphical representation, such as a plot-out) of the permanent storage unit 122 and activate the physical destruction element 350 at the location(s) 324 to physically destroy the permanent storage device(s) 122 within the computing device 120. As previously mentions, robotics mechanisms (not shown in FIG. 3A) may be implemented to position the computing device 120 proximate the physical destruction element 350 such that the physical destruction element 350 is activated specifically at the location(s) 324 of the permanent storage device(s)/unit(s) 122.

In specific embodiments of the apparatus 100, once the permanent storage device(s) 122 have been destroyed, the apparatus 100 may be configured to return the computing device 120 and/or permanent storage devices 122 to the user 110 or, in other embodiments of the invention, the apparatus may be configured, by the user, to designate the computing device 120 and/or the permanent storage devices 122 for re-cycling.

Referring to FIG. 3B, memory 302 of computing platform 300 stores physical destruction record module 370 that is configured to generate a physical destruction record 376 that includes, but is not limited to a user identifier 110-1, computing device identifier 120-1 (e.g., serial number, International Mobile Equipment Identity (IMEI) number or the like), and date/time 378 of the physical destruction. In specific embodiments of the invention, physical destruction record module 370 is configured to activate the image-capturing device(s) 330 to capture one or more images 336 of the destroyed storage device(s) 372 and/or video 338 of the actual physical destruction process 374 and include the images 336 and/or the video 338 in the physical destruction record 376. In other embodiments of the apparatus 100, the housing/kiosk 200 may be equipped with a transparent facing (e.g., window or the like) that allows the user 110 to view the physical destruction of the permanent storage units 122. In response to generating the physical destruction record, physical destruction record module 370 is configured to initiate communication 380 of the physical destruction record 376 to a record database 382 and/or the user 110.

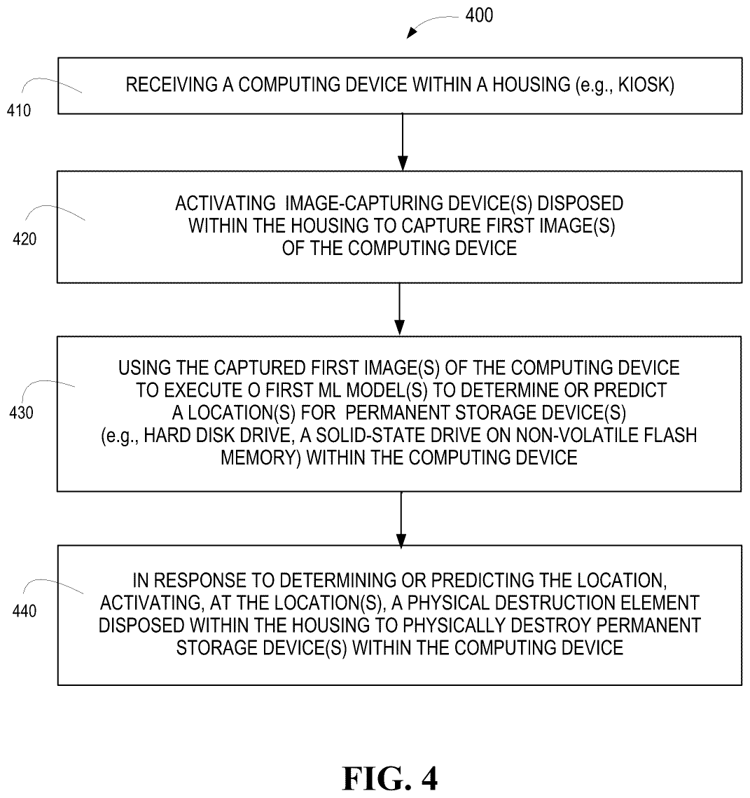

Referring to FIG. 4, a flow diagram is a depicted of a method 400 for secure physical destruction of computing devices, specifically the permanent storage devices disposed within such computing devices, in accordance with embodiments of the present invention. At Event 410, a computing device is received within a housing, such as a self-service kiosk or the like. In response to receiving the computing device, at Event 420, image-capturing device(s) disposed within the housing is/are activated to capture first images of the computing device and, in specific embodiments determining physical dimensions of the computing device.

In response to capturing the images, at Event 430, trained ML models are executed, using the captured images and, in some embodiments determined physical dimensions as inputs, to determine, or otherwise predict, the location of the permanent storage devices/units (e.g., hard drive disk, solid-state disk, non-volatile flask memory or the like) within the computing device. In specific embodiments, the ML models implement image recognition techniques, such as computer vision techniques and the like to generate a visual representation (e.g., plot-out or the like) of the location(s).

In response determining/predicting the location of the permanent storage devices within the computing device, at Event 640, a physical destruction element (e.g., drill, saw, laser, pulverizer, heating element or the like) is activated at the determined/predicted location within the computing device to physically destroy the permanent storage device (i.e., put a hole through, cut in half/segments, burn, disintegrate or the like).

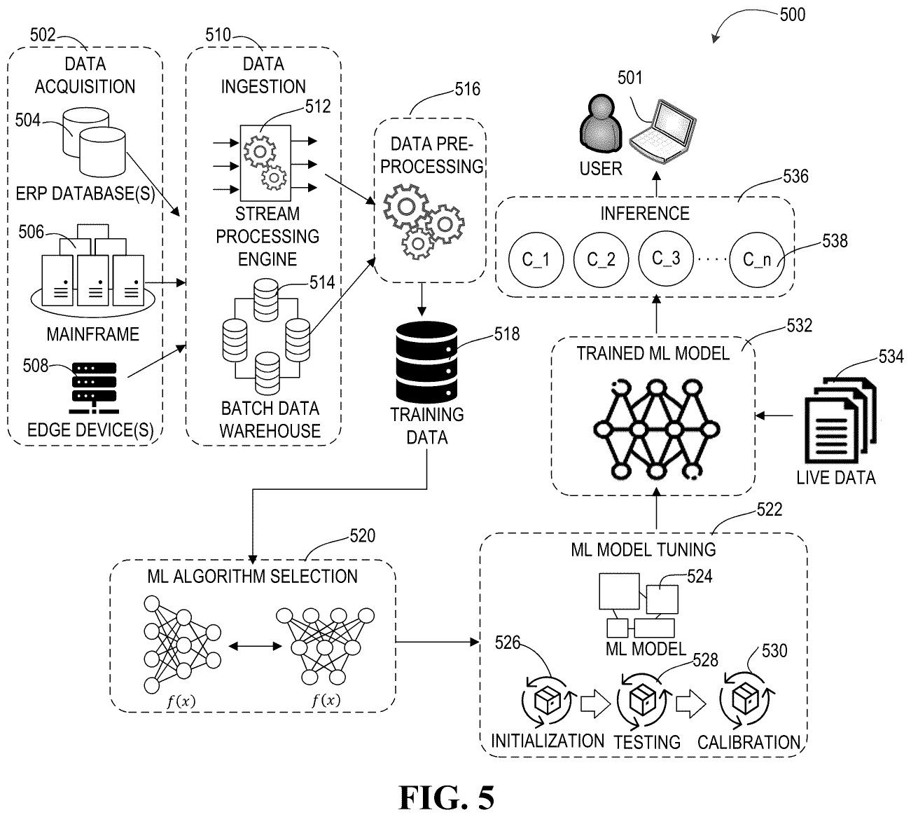

FIG. 5 illustrates an exemplary machine learning (ML) subsystem architecture 600, in accordance with an embodiment of the invention. The machine learning subsystem 500 includes a data acquisition engine 502, data ingestion engine 510, data pre-processing engine 516, ML model tuning engine 522, and inference engine 536.

The data acquisition engine 502 identifies various internal and/or external data sources to generate, test, and/or integrate new features for training the machine learning model 524. These internal and/or external data sources 504, 506, and 508 may be initial locations where the data originates or where physical information is first digitized. The data acquisition engine 502 identifies the location of the data and describes connection characteristics for access and retrieval of data. In some embodiments, data is transported from each data source 504, 506, or 508 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources include Enterprise Resource Planning (ERP) database(s) 504 that host data related to day-to-day business activities such as accounting, procurement, project management, exposure management, supply chain operations, and/or the like, mainframe 506 that is often the entity's central data processing center, edge device(s) 508 that may be any piece of hardware, such as sensors, actuators, gadgets, appliances, or machines, that are programmed for certain applications and can transmit data over the internet or other networks, and/or the like. The data acquired by the data acquisition engine 502 from these data sources 504, 506, and 508 is transported to the data ingestion engine 510 for further processing.

Depending on the nature of the data imported from the data acquisition engine 502, the data ingestion engine 510 may move the data to a destination for storage or further analysis. Typically, the data imported from the data acquisition engine 502 is in varying formats as the data comes from different sources, including Rational Database Management Systems (RDBMs), other types of databases, Simple Storage Service (S3) buckets, Commas-Separated Value (CSVs), or from streams. Since the data comes from different entities, the data needs to be cleansed and transformed so that it can be analyzed together with data from other sources. At the data ingestion engine 510, the data may be ingested in real-time, using the stream processing engine 512, in batches using the batch data warehouse 514, or a combination of both. The stream processing engine 512 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 514 collects and transfers data in batches according to scheduled intervals, trigger events, or any other logical ordering.

In machine learning, the quality of data and the useful information that can be derived therefrom directly affects the ability of the machine learning model 524 to learn. The data pre-processing engine 516 implements advanced integration and processing steps needed to prepare the data for machine learning execution. This includes modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 516 implements feature extraction and/or selection techniques to generate training data 518. Feature extraction and/or selection is a process of dimensionality reduction by which an initial set of data is reduced to more manageable groups for processing. A characteristic of these large data sets is a large number of variables that require sizeable computing resources to process. Feature extraction and/or selection may be used to select and/or combine variables into features, effectively reducing the amount of data that must be processed, while still accurately and completely describing the original data set. Depending on the type of machine learning algorithm being used, training data 518 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 522 may be used to train a machine learning model 524 using the training data 518 to make predictions or decisions without explicitly being programmed to do so. The machine learning model 524 represents what was learned by the selected machine learning algorithm 520 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 522 repeatedly executes cycles of initialization/experimentation 526, testing 528, and tuning 530 to optimize the performance of the machine learning model 524 and refine the results in preparation for deployment of those results for consumption or decision making. To this end, the ML model tuning engine 522 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 518. A fully trained machine learning model 532 is one whose hyperparameters are tuned and model accuracy maximized.

The trained machine learning model 532, similar to any other software application output, can be persisted to storage, file, memory, or application, or looped back into the processing component to be reprocessed. More often, the trained machine learning model 532 is deployed into an existing production environment to make practical decisions based on live data 534 (such as, in accordance with the present invention, signals from beacons, data derived from beacon signals, movement/route maps and the like). To this end, the machine learning subsystem 500 uses the inference engine 536 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 538) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 538) live data 534 based on how similar they are to one another to solve exploratory challenges where little is known about the data, provide a description or label (e.g., C_1, C_2 . . . . C_n 538) to live data 734, such as in classification, and/or the like. These categorized outputs, groups (clusters), or labels are then presented to the user input system 701. In still other cases, machine learning models that perform regression techniques may use live data 734 to predict or forecast continuous outcomes.

It will be understood that the embodiment of the machine learning subsystem 700 illustrated in FIG. 5 is exemplary and that other embodiments may vary. As another example, in some embodiments, the machine learning subsystem 700 includes more, fewer, or different components.

Thus, as described in detail above, present embodiments of the invention include systems, methods, computer program products and/or the like that provide a self-service means for destroying computing devices, specifically the permanent storage/memory devices/units within such computing devices. In this regard, the invention embodies an apparatus, such as a kiosk with a receptacle for receiving a user's computing device. Once the computing device has been received at the kiosk, an image-capturing device(s) is activated to capture images of the computing device. The captured images serve as inputs to Machine Learning (ML) models that have been trained to determine/predict the location of permanent storage/memory devices/units within the computing devices. The permanent storage/memory device will vary depending on the type of device and may include a hard disk drive, a solid-state drive, non-volatile flash memory or the like. Once the location has been determined, a physical destruction element is activated at the determined/predicted location to destroy the permanent storage/memory devices/units.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for secure physical destruction of computing devices, the apparatus comprising:
a housing having a receptacle configured to receive a computing device from a user;
a computing platform disposed within the housing and comprising:
a memory;
one or more computing processor devices in communication with the memory;
at least one image capturing device in communication with at least one of the one or more computing processor devices;
a physical destruction element in communication with at least one of the one or more computing processor devices;
a storage device location-determining module including one or more trained Machine Learning (ML) models, wherein the storage device location-determining module is stored in the memory, executable by at least one of the one or more computing processor devices and is configured to:
activate the at least one image capturing device to capture one or more first images of the computing device,
using the captured one or more first images of the computing device, execute one or more first ML models from amongst the one or more trained ML models to determine or predict a location for at least one permanent storage device within the computing device, wherein the least one permanent storage device includes at least one of a hard disk drive, a solid-state drive on non-volatile flash memory; and
a physical destruction module stored in the memory, executable by at least one of the one or more computing processor devices and is configured to:
receive the location for the least one permanent storage device within computing device, and
activate the physical destruction element at the location to physically destroy the at least one permanent storage device within the computing device.

2. The apparatus of claim 1, wherein the storage device location-determining module is further configured to:
using the captured one or more first images of the computing device, execute one or more second ML models from the one or more trained ML models to determine or predict at least one of a manufacturer and a model number of the computing device, and
using the at least one of the manufacturer and the model number of the computing device, execute the one or more first ML models to determine or predict the location for the at least one permanent storage device within the computing device.

3. The apparatus of claim 1, wherein the storage device location-determining module is further configured to:
activate the at least one image capturing device to determine physical dimensions of the computing device, and
further using the physical dimensions of the computing device, execute one or more first ML models from amongst the one or more trained ML models to determine or predict a location for at least one permanent storage device within the computing device.

4. The apparatus of claim 1, wherein the storage device location-determining module is further configured to:
using the captured one or more first images of the computing device, execute the one or more first ML models to determine or predict a location for at least one permanent storage device within the computing device, wherein the one or more first ML models implement computer vision techniques that are configured to provide a visual representation of the location of the at least one permanent storage device within the computing device.

5. The apparatus of claim 1, wherein the computing platform further comprises:
a physical destruction record module stored in the memory, executable by at least one of the one or more computing processor devices and is configured to:
generate a physical destruction record that includes (i) an identity of the user, (ii) a unique identifier for the computing device and (iii) a time at which the at least one permanent storage device was physically destroyed, and
initiate communication of the physical destruction record to at least one of (i) the user and (ii) a physical destruction database.

6. The apparatus of claim 5, wherein the physical destruction record module is further configured to:
activate the at least one image capturing device to capture at least one of a video or one or more second images of the physical destruction element destroying the at least one permanent storage device within the computing device, and
generate the physical destruction record that further includes the at least one of the video and the one or more second images.

7. The apparatus of claim 6, wherein the physical destruction record module is further configured to:
acquire the unique identifier for the computing device, wherein the unique identifier is one chosen from the group consisting of (i) a serial number of the computer device, and (ii) an International Mobile Equipment Identity (IMEI) number.

8. The apparatus of claim 1, wherein the computing platform further comprises:
a physical destruction authorization module stored in the memory, executable by at least one of the one or more computing processor devices and is configured to:
acquire a unique identifier for the computing device, wherein the unique identifier is one chosen from the group consisting of (i) a serial number of the computer device, and (ii) an International Mobile Equipment Identity (IMEI) number,
access a device database that includes identifiers for computing devices that are not authorized for destruction and verify that the unique identifier for the computing device is not listed within the device database, and
in response to verifying that the unique identifier of the computing device is not listed within the device database, authorize the computing device for physical destruction of permanent storage devices.

9. The apparatus of claim 8, wherein the physical destruction authorization module is further configured to:
access the device database and determine that the unique identifier for the computing device is listed within the device database, and
in response to determining that the unique identifier of the computing device is listed within the device database, deny the computing device from undergoing physical destruction of permanent storage devices.

10. The apparatus of claim 8, wherein the physical destruction authorization module is further configured to:
in response to determining that the unique identifier of the computing device is listed within the device database, activate one or more of the at least image capturing devices to capture an image of the user, and
initiate communication of the image of the user to a third-party entity.

11. The apparatus of claim 1, wherein the computing platform further comprises:
a physical destruction authorization module stored in the memory, executable by the at least one of the one or more computing processor devices and is configured to:
verify that the user is an authorized user of the computing device, and
in response to verifying that the user is the authorized user of the computing device, authorize the computing device for physical destruction of permanent storage devices.

12. The apparatus of claim 1, wherein the physical destruction element is further defined as chosen from the group consisting of (i) a cutting element, (ii) a pulverizer and (iii) a burning element.

13. A computer-implemented method for secure physical destruction of computing devices, the computer-implemented method executed by one or more computing processor device and comprising:
activating at least one image capturing device disposed within a housing to capture one or more first images of a computing device located within the housing;
using the captured one or more first images of the computing device to execute one or more first ML models to determine or predict a location for at least one permanent storage device within the computing device, wherein the least one permanent storage device includes at least one of a hard disk drive, a solid-state drive on non-volatile flash memory; and
in response to determining or predicting the location, activating a physical destruction element disposed within the housing at the location to physically destroy the at least one permanent storage device within the computing device.

14. The computer-implemented method of claim 13, wherein using the captured one or more first images of the computing device to execute the one or more first ML models to determine or predict the location for the at least one permanent storage device further comprises implementing computer vision techniques that are configured to provide a visual representation of the location of the at least one permanent storage device within the computing device.

15. The computer-implemented method of claim 13, further comprising:
acquiring a unique identifier for the computing device, wherein the unique identifier is one chosen from the group consisting of (i) a serial number of the computer device, and (ii) International Mobile Equipment Identity (IMEI) number;
activating at least one image capturing device to capture at least one of a video or one or more second images of the physical destruction element destroying the at least one permanent storage device within the computing device;
generating a physical destruction record that includes (i) an identity of the user, (ii) a unique identifier for the computing device and (iii) a time at which the at least one permanent storage device was physically destroyed, and (iv) the at least one of the video and the one or more second images; and
initiating communication of the physical destruction record to at least one of (i) the user and (ii) a physical destruction database.

16. The computer-implemented method of claim 13, further comprising:
acquiring a unique identifier for the computing device, wherein the unique identifier is one chosen from the group consisting of (i) a serial number of the computer device, and (ii) International Mobile Equipment Identity (IMEI) number;
accessing a device database that includes identifiers for computing devices that are not authorized for destruction and verifying that the unique identifier for the computing device is not listed within the device database; and
in response to verifying that the unique identifier of the computing device is not listed within the device database, authorizing the computing device for physical destruction of permanent storage devices.

17. A computer program product including a non-transitory computer-readable medium, the non-transitory computer-readable medium comprising sets of codes for causing one or more computing devices to:
activate at least one image capturing device disposed within a housing to capture one or more first images of a computing device located within the housing;
use the captured one or more first images of the computing device to execute one or more first ML models to determine or predict a location for at least one permanent storage device within the computing device, wherein the least one permanent storage device includes at least one of a hard disk drive, a solid-state drive on non-volatile flash memory; and
activate a physical destruction element disposed within the housing at the location to physically destroy the at least one permanent storage device within the computing device.

18. The computer program product of claim 17, wherein the set of code for causing the one or more computing devices to use the captured one or more first images of the computing device to execute one or more first ML models to determine or predict a location for at least one permanent storage device within the computing device are further configured to cause the one or more computing devices to implement computer vision techniques that are configured to provide a visual representation of the location of the at least one permanent storage device within the computing device.

19. The computer program product of claim 17, wherein the computer-readable medium further comprises sets of codes for causing the one or more computing devices to:
acquire a unique identifier for the computing device, wherein the unique identifier is one chosen from the group consisting of (i) a serial number of the computer device, and (ii) International Mobile Equipment Identity (IMEI) number;
activate at least one image capturing device to capture at least one of a video or one or more second images of the physical destruction element destroying the at least one permanent storage device within the computing device;
generate a physical destruction record that includes (i) an identity of the user, (ii) a unique identifier for the computing device and (iii) a time at which the at least one permanent storage device was physically destroyed, and (iv) the at least one of the video and the one or more second images; and
initiate communication of the physical destruction record to at least one of (i) the user and (ii) a physical destruction database.

20. The computer program product of claim 17, wherein the computer-readable medium further comprises a set of codes for causing the one or more computing devices to:
acquire a unique identifier for the computing device, wherein the unique identifier is one chosen from the group consisting of (i) a serial number of the computer device, and (ii) International Mobile Equipment Identity (IMEI) number;
access a device database that includes identifiers for computing devices that are not authorized for destruction and verifying that the unique identifier for the computing device is not listed within the device database; and
in response to verifying that the unique identifier of the computing device is not listed within the device database, authorize the computing device for physical destruction of permanent storage devices.
